(19) United States
(12) Patent Application Publication
(10) Pub. No.: US 2023/0342664 A1
(43) Pub. Date: Oct. 26, 2023

(54) METHOD AND SYSTEM FOR DETECTION AND MITIGATION OF CONCEPT DRIFT

(71) Applicant: B. G. NEGEV TECHNOLOGIES AND APPLICATIONS LTD., AT BEN-GURION UNIVERSITY, Beer Sheva (IL)

(72) Inventors: Boaz LERNER, Mazkeret Batya (IL); Liran NAHUM, Tel Aviv (IL); Moriya COHEN, Afula (IL); Shon MENDELSON, Beer Sheva (IL)

(21) Appl. No.: 18/015,068

(22) PCT Filed: Jul. 8, 2021
(86) PCT No.: PCT/IL2021/050840

§ 371 Date: Jan. 8, 2023

Related U.S. Application Data
(60) Provisional application No. 63/049,135, filed on Jul. 8, 2020.

(51) Int. Cl. G06N 20/00; G06N 7/01

(52) U.S. Cl. CPC G06N 20/00; G06N 7/01

(57) ABSTRACT

A system and method of detecting Concept Drift (CD) using a Bayesian Network (BN) model may include: receiving a first version of the BN model, comprising a plurality of interconnected nodes, each node comprising a conditional probability table (CPT) representing statistic characteristics of a corresponding domain variable; computing at least one CPT of at least one node of the first version BN based on an incoming data stream to produce a second version of CPTs representing a second version of the BN; calculating a CPT distance value between at least one first CPT of the first version and at least one corresponding second CPT of the second version; identifying at least one suspected node of the BN as undergoing CD based on the at least one calculated CPT distance value; and producing an optimized version of the BN based on the identification of the suspected node.

### CROSS-REFERENCE TO RELATED APPLICATIONS

This application claims the benefit of priority of U.S. Patent Application No. 63/049,135, filed Jul. 8, 2020, and entitled: “Concept-drift detection and re-learning for streaming data” which is hereby incorporated by reference in its entirety.

### FIELD OF THE INVENTION

The present invention relates generally to the field of machine learning applications. More specifically, the present invention relates to detection of concept drift (CD) in a domain by a Bayesian network (BN).

### BACKGROUND OF THE INVENTION

Our world is dynamic. Consumer habits, machine state, manufacturing processes, and health condition are just a few examples. Changes in a domain can make our existing concept of the domain irrelevant and misleading. These may be abrupt or incremental (“drift”). While root causes may be the heart of a CD, detection of drifts, accumulated over time, and root causes, let alone drift mitigation, are both challenging, nevertheless crucial. A deterministic model cannot cope with a dynamic domain and its drift. Even a dynamic model neither can easily reveal changes and root causes in the domain nor cope with drifts. State-of-the-art algorithms for CD detection and mitigation usually use a “bank” of models, either fixed/static, dynamic, or statistical, or alternatively, relearn the model occasionally or after suspecting a drift. Neither a “bank” of models nor relearning are practical or can be accurate enough as the domain becomes more and more complex and changes more often.

### SUMMARY OF THE INVENTION

Embodiments of the invention may include a method of detecting CD, by at least one processor, using a BN model. Embodiments of the method may include, for example receiving a first version of the BN model, that may include a plurality of interconnected nodes. Each node may include a conditional probability table (CPT) representing statistic characteristics of a corresponding domain variable. Embodiments of the method may compute at least one (e.g., all) CPT of at least one (e.g., all) node of the first version BN based on an incoming data stream to produce a second version of CPTs representing a second version of the BN; Calculate a CPT distance value between at least one first CPT of the first version and at least one corresponding second CPT of the second version; and identify at least one suspected node of the BN as undergoing CD based on the at least one calculated CPT distance value. According to some embodiments, computing at least one CPT may include computing all CPTs of the BN.

According to some embodiments, the CPT of at least one first node may include one or more conditional probability distribution (CPD) entries, and wherein each CPD entry represents probabilities of domain variable values of the first node conditioned on values of domain variables that may be represented by one or more parent nodes of the first node.

According to some embodiments, calculating the CPT distance between the first CPT and the second CPT may include: calculating one or more CPD difference metric values between the CPDs of the first CPT and the CPDs of the second CPT; and calculating the CPT distance as a function of the one or more CPD difference metric values. According to some embodiments, this function may be a weighted sum of CPD difference metric values. Additionally, or alternatively, this function may be for example the Shewhart control or Exponentially Weighted Moving Average (EWMA) charts applied to the weighted sum of CPD difference metric values, or the multivariate EWMA (MEWMA) or Hotelling T² charts applied to the concatenation of the CPD difference metric values.

According to some embodiments, the CPD difference metrics may include, for example Total Variation (TV) distance, Pearson Chi-square Statistic (CS) test, Kullback-Leibler (KL) divergence, and Hellinger distance.

According to some embodiments, identifying at least one suspected node may include applying statistical process control (SPC) to determine whether the at least one calculated CPT distance value represents CD.

Additionally, or alternatively, identifying at least one suspected node may include: monitoring at least one CPT distance value of the at least one node; calculating, for at least one node, a distance limit value based on the CPT distance of that node; analyzing the monitored CPT distance value in relation to the calculated distance limit value; and identifying the at least one node as suspected of undergoing CD based on the analysis.

According to some embodiments, analyzing the at least one CPT distance value may include applying an SPC algorithm on the monitored at least one CPT distance value and the distance limit value, to identify the at least one node as suspected of undergoing CD. Said SPC algorithm may include, for example Shewhart chart, Exponentially Weighted Moving Average (EWMA) chart, multivariate EWMA (MEWMA) chart, and Hotelling T² chart. According to some embodiments, the distance limit value may be determined dynamically based on the monitored CPT distance values.

Embodiments of the invention may include producing an optimized version of the BN based on the at least one identified suspected node; receiving a set of domain variable values corresponding to nodes of the optimized version of the BN; and predicting at least one value of at least one domain variable based on the optimized version of the BN.

Embodiments of the invention may perform a local relearning (LRL) process that may include: producing a plurality of directed acyclic graphs (DAGs), wherein each DAG may include nodes of the BN, and represents a single structural change in the BN in relation to at least one suspected node; for each DAG of the plurality of DAGs, calculating a statistical score, representing a likelihood that the DAG corresponds to the incoming data stream; selecting a DAG among the plurality of DAGs based on the calculated statistical scores; and producing an optimized version of the BN based on the selected DAG.

According to some embodiments, the LRL process may be an iterative process. Each iteration of the LRL process may include producing a plurality of DAGs; selecting an optimal DAG, representing a single structural change in the BN in relation to a previous iteration, based on the calculated statistical scores; calculating an improvement of the statistical score of the selected DAG in relation to the statistical score of a selected DAG of the previous iteration; and repeating the iterative process, with the selected optimal DAG, based on the calculated improvement. The iterative LRL process may be repeated as long as the statistical score of the selected DAG improves beyond a predefined threshold.

According to some embodiments, an optimal DAG of a current iteration may be associated with a current statistical score, and an optimal DAG of a previous iteration may be associated with a previous, not inferior statistical score. Repeating the iterative LRL process may include calculating a selection probability; and selecting the optimal DAG of the current iteration based on the selection probability.

According to some embodiments, the selection probability may be set to decline over time or over iterations. For example, the selection probability may be calculated such that for each pair of consecutive iterations of the LRL process, the selection probability of a first iteration of the pair of iterations may be higher than the selection probability of a second, later iteration of the pair of iterations.

Embodiments of the invention may include a system for detecting CD using a BN model. Embodiments of the system may include: a non-transitory memory device, wherein modules of instruction code may be stored, and at least one processor associated with the memory device, and configured to execute the modules of instruction code. Upon execution of said modules of instruction code, the at least one processor may be configured to: receive a first version of the BN model, may include a plurality of interconnected nodes, each node may include a CPT representing statistic characteristics of a corresponding domain variable; compute at least one CPT of at least one node of the first version BN based on an incoming data stream to produce a second version of the BN; calculate a CPT distance value between at least one first CPT of the first version and at least one corresponding second CPT of the second version; and identify at least one suspected node of the BN as undergoing CD based on the at least one calculated CPT distance values.

Embodiments of the invention may include a method of mitigating, by at least one processor, CD using a BN model. Embodiments of the method may include: receiving a first version of the BN model, corresponding to a first timing, said BN model may include a plurality of interconnected nodes, wherein each node represents a domain variable; receiving a second version of the BN model, corresponding to a second timing; identifying at least one node of the BN as suspected of undergoing CD between the first version of the BN model and the second version of the BN model; and locally relearning the BN based on the at least one identified suspected node.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram depicting a computing device which may be included in a system for detection of CD using a BN according to some embodiments;

FIG. 2 is a schematic diagram depicting an example of a BN model, which may be analyzed to identify CD according to some embodiments of the invention;

FIG. 3 depicts an example of pseudo-code for a local relearning algorithm, according to some embodiments of the invention;

FIGS. 4A and 4B are block diagrams depicting embodiments of a system for detecting and/or mitigating CD using a BN, according to some embodiments of the invention;

FIG. 5 is a block diagram depicting modules of a system for detecting CD in a domain using a BN model and re-learning the model to suit the drifted domain, according to some embodiments of the invention;

FIG. 6 is a block diagram depicting components of a relearning module, which may be included in a system for detecting and/or mitigating CD using a BN, according to some embodiments of the invention; and

FIG. 7 is a flow diagram depicting a method for detecting and/or mitigating CD using a BN, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention may include a method and a system for detection and/or mitigation of CD in a domain by using a BN, in view of streaming input data. Additionally, embodiments of the invention may include identification of specific nodes of the BN, this identification manifests the detected CD in the domain through the BN, and employment of selective relearning of portions of the BN, based on the identified nodes, to overcome the CD.

The following table, Table 1, includes a glossary of terms used herein.

TABLE 1

| | |
|---|---|
| Domain data, | The terms “domain data” and “domain variable(s)” may be used herein |
| Domain | to indicate a field of knowledge to which embodiments of the invention |
| variable(s) | may be applied. For example, embodiments of the invention may be |
| | applied to domain data of the agriculture field of knowledge, and a |
| | respective set of domain variables may include a type of soil of a plant, |
| | an amount of irrigation provided to the plant, an amount of lighting that |
| | the plant receives, and the like. |
| Bayesian | The term “Bayesian network” (e.g., a Bayesian network implementing a |
| network (BN) | machine learning (ML) or artificial intelligence (AI) function) may be |
| | used herein to refer to a probabilistic graphical model that may represent |
| | a set of domain variables. |
| | The structure of a BN is a directed acyclic graph (DAG), consisting of a |
| | plurality of interconnected nodes. Each node of the BN represents a |
| | domain variable. Unconnected nodes represent conditional |
| | independence between corresponding variables. Directed edges |
| | connecting the BN nodes may represent probabilistic, causal relations |
| | between the corresponding domain variables. The structure and |
| | probability relations compose the BN. |
| | A BN is learned (as commonly referred to in the art) in an unsupervised |
| | process to represent a domain in a specific field of knowledge. Learning |
| | a BN may involve (a) learning first its structure, e.g., identifying the |
| | edges and causal relations they represent, and (b) learning the |
| | probabilistic relations (also referred to herein as “parameters”) that |
| | quantify the edges. |
| Prediction | The term “prediction” may be used herein to indicate mapping by the BN |
| | model of given input data, pertaining to at least one domain variable |
| | represented by the BN model, to a target variable value (e.g., a value of |
| | a target domain variable). |
| Concept drift | The term “concept drift” may be used herein in the context of a BN model |
| (CD) | to indicate a change, which may be manifested over time, in the |
| | relationship between variables in the underlying problem. This change |
| | may include, for example, a gradual change over time in statistical |
| | characteristics (e.g., mean, standard deviation (STD)) of at least one |
| | domain variable. As known in the art, a CD may for example, be caused |
| | or triggered by an unforeseen change in statistical characteristics of the |
| | incoming data, or due to onset of an effect of a hidden variable on the |
| | input data. |
| | As known in the art, a CD may cause a learned BN model (e.g., a BN |
| | model that has been learned using old data) to perform poorly in |
| | predicting an output value or representing the domain in view of new |
| | input data. |
| Target | The term “target variable” may be used herein to refer to a domain |
| variable | variable of interest, e.g., a domain variable to be predicted by an |
| | ML-based model. Embodiments of the invention may identify CD of any |
| | domain variable represented by a node in a BN, and may therefore not |
| | be limited to any specific target variable. |

Embodiments of the invention may include a system and method of performing a two-stage algorithm for CD detection and mitigation using a BN. This two-stage algorithm may efficiently adapt or retrain at least a portion of the BN to follow changes in the distribution of input data streams over time and relearn a new BN model modified to the changes, as elaborated herein.

In a first stage, embodiments of the invention may calculate evolution of statistical distances between conditional parameter tables (CPTs) of the BN over time, using statistical process control (SPC) charts. Based on the calculated statistical distances, embodiments of the invention may identify parametric and/or structural changes that may be needed in the network in order to follow the drifted concept, as elaborated herein.

In a second stage, embodiments of the invention may optimally select portions of the BN, and locally re-learn, or retrain the selected portions in an unsupervised manner, based only on the identified required changes, as elaborated herein.

It may be appreciated by a person skilled in the art that such local re-learning of portions of the BN may dramatically reduce the consumption of computing resources (e.g., time, memory, storage, computing cycles, power, etc.) that may be required for retraining or relearning the BN so as to overcome CD. This reduction of computing resources may, in turn, result in efficient, rapid, and accurate performance of machine-learning based applications in a variety of domains. Moreover, experimental results have shown that the unsupervised CD detection and re-learning of BNs as elaborated herein may be comparable, and typically surpass performance of currently available, supervised ML-based classification algorithms for overcoming CD. Additionally, embodiments of the invention may identify CD in a non-target variable whether a target variable exist or absent, which is a capability that currently available supervised concept drift detection algorithms may not be able to provide.

As known in the art, most available ML models assume that data input to the models (e.g., “examples”, as commonly referred to in the art) is generated by a stable process, or “in-control” process, as commonly referred to in the art, which may have a stationary statistic distribution. However, and as may be appreciated by a person skilled in the art, this assumption is not true in many applications. Statistical characteristics of incoming data streams may change over time, becoming “out-of-control” as commonly referred to in the art. Such a change of statistical characteristics may result in a condition that is commonly referred to as concept drift. A change in statistical characteristics of the incoming data may arise from a plurality of reasons, including for example the effect of hidden domain variables, which may not be explicitly introduced into the ML model.

For example, in the data domain of economics, an ML model may predict a data variable such as a price of a product. The ML model may receive, as explicit input, data pertaining to a level of inflation, and may be trained to predict a nominal price of the product based on the inflation data input. However, the effect of other observed variables, as well as latent variables, which may not be explicitly input to the model (e.g., changing needs of an aging population, the effect of global warming, equipment wear, etc.), may affect the target variable in ways that were unforeseen at the time of model training. Furthermore, the effect of any such observed or latent variables may change over time, resulting in CD.

As known in the art, CD may be referred to as either “real” or “virtual”. A “real” CD may refer to a change in a conditional distribution P(y|X), where y is a target variable and X is a set of input domain variables X={x₀, x₁, . . . , xₙ}. A “virtual” CD may refer to a change in the unconditional probability distribution/density p(X). Usually, a “real” CD may be considered more important to detect, as it may require updating a model's decision boundary, but a “virtual” drift may be harder to detect because after the data distribution changes, the existing decision boundary cannot fit this distribution anymore. Also known is a “dual” CD, if changes occur in both P(y|X) and p(X).

Embodiments of the invention may be adapted to detect and/or overcome CD in streaming input data, where a target variable may change over time. For example, in the data domain of economics, when creating a new brand for a product, a target variable may initially be whether a customer will mouse-click an advertisement for the product. In a later stage (e.g., when the brand is established), the target variable may be whether the customer will buy the product (and the former target variable may now be used as an explanatory variable).

In the unsupervised setting, the separation between virtual and real CD is irrelevant, and each change in the distribution should be detected and treated. Unsupervised approaches for CD detection normally include non-parametric tests, as they may be an excellent scheme for general problems that require no assumptions.

It may be appreciated that in a BN, each domain variable (represented by a node of the BN) may be a target variable. Therefore, a BN may be applied to predict a value of each domain variable that is represented by a node of the BN. Embodiments of the invention may exploit this feature to detect and/or overcome CD of any target variable that may be represented by a node of the BN.

As known in the art, the number of possible BN structures, manifested by different configurations of interconnecting edges, grows exponentially with the number of nodes of the BN. Thus, in most domains, learning the structure from data by considering all possible BN structures may not be feasible, regardless of the size and/or influx of data. In other words, brute-force learning a BN structure is an NP-hard problem, which therefore requires sub-optimal procedures. This makes utilizing a BN in a streaming setting even more challenging, since the model should be continuously updated rather than relearned from scratch.

Embodiments of the invention may continuously (e.g., recurrently through time) employ a two-stage algorithm, which may be referred to herein as a Concept Drift Detection and Relearning (CDDRL) algorithm.

According to some embodiments, at each time step, at a first stage, the CDDRL algorithm may sequentially or continuously monitor distances between estimated, current values of CPTs of the BN and CPT values corresponding to a snapshot of the BN in a previous stable condition. The CDDRL algorithm may subsequently detect CD by applying an SPC algorithm to the monitored distances. It may be appreciated that the CDDRL algorithm may not only detect a change that has occurred due to a CD, but may also identify nodes of the BN as suspected of undergoing CD. The time step for continuous monitoring of distances may be defined, for example, as an elapse of predefined time period, an occurrence of synchronous event (e.g., a synchronous interrupt), an asynchronous event (e.g., reception of a predefined amount of incoming data) and the like. At a second stage, the CDDRL algorithm may perform an iterative search among a plurality of candidate DAGs, each including the at least one suspected node, as this at least one node suspected of undergoing CD triggers solicitation for an updated model. The term “candidate” may be used in this context in a sense that each DAG may be a candidate for mitigating the CD using the BN, and embodiments of the invention may select an optimal DAG among the plurality of candidate DAGs to optimally mitigate CD using the BN.

According to some embodiments, the CDDRL algorithm may score each of the candidate DAGs and select the DAG having the best (e.g., highest) score to locally modify the BN and create an optimized version of the initial, stable BN after mitigating the CD, as elaborated herein.

Currently available methods of CD detection include a preliminary stage of detecting and removing drifted input data (e.g., “examples”, as commonly referred to in the art), and a second stage, in which training of an ordinary classifier (e.g., a K-nearest-neighbor classifier) is improved in absence of the drifted examples.

Other currently available supervised algorithms for CD detection are based on ensembles of ML models. Member ML models in an ensemble are weighted by their contribution to correct classification or to decide which model to remove from, and which new models to add to the ensemble. Such currently available methods are directed to mitigate CD in the class variable (e.g., “real” CD) by improving a classifier, but do not detect drifted domain variables that may be a source of a change, and do not include local relearning of a classifier based on the detected domain variables.

In contrast, embodiments of the invention (e.g., the CDDRL algorithm) may (a) detect and/or alert on drifted domain variables (e.g., nodes of the ML model), (b) detect drift in any, not just the class, variable, (c) identify root causes for drift of domain variables, and/or (d) apply local relearning of the ML model based on the detected, drifted nodes to update the model to the drifted domain.

Embodiments of the invention may include an improvement over currently available methods of CD discovery using BN models. For example, the CDDRL algorithm may perform the search for an optimal DAG according to the nodes that have first been detected as changed or suspected. Thus, the CDDRL algorithm may avoid the need to globally learn the BN model at each time step or iteration.

As known in the art, most existing approaches for CD discovery and mitigation (e.g., ensemble methods, where, e.g., each classifier in the ensemble is trained for a different time interval) include supervised learning of an ML-based model and may thus be unable to handle unsupervised tasks or scenarios in which a non-target domain variable changes over time. Embodiment of the invention (e.g., the CDDRL algorithm) may include an improvement over currently available technology of CD discovery and mitigation by detecting changes in the distribution of any domain variable (e.g., target or non-target domain variable) using the BN and mitigating the CD accordingly.

Additionally, embodiments of the invention (e.g., the CDDRL algorithm) may not learn or train the BN structure at each time step from scratch. Instead, as elaborated herein, the relearning of the BN model may be performed at each time step locally in relation to, and as triggered by nodes that were previously detected or identified as suspected as undergoing CD and the best model known by this time step. Thus, embodiment of the invention may improve ML-based technology by facilitating CD detection and mitigation in real time, or near-real time, for a streaming data input setting.

Additionally, embodiments of the invention (e.g., the CDDRL algorithm) may provide an improvement of currently available CD discovery methods. Since, as elaborated herein, the CDDRL may search for a concept drift over all domain variables of the BN and their interrelations, some are causal, it may facilitate identification of a cause of a source of the concept drift. It may be appreciated that this is a capability that currently available methods and systems for CD mitigation lack.

As elaborated herein, experimental results have demonstrated the impact and advantages of the abovementioned improvements in technology over currently available methods and systems for CD discovery and mitigation. A first set of experiments used, as input, synthetic data for classification tasks with various concept drift structures, such as sudden CD and gradual CD.

A second set of experiments used data that was generated from BNs that are used in the art, and for which, the true networks (structure and probabilities) are known, and the CD was introduced by changing the BN structure. Such changes in the BN structure may include, for example adding an edge, removing an edge, and/or reversing a direction of an edge.

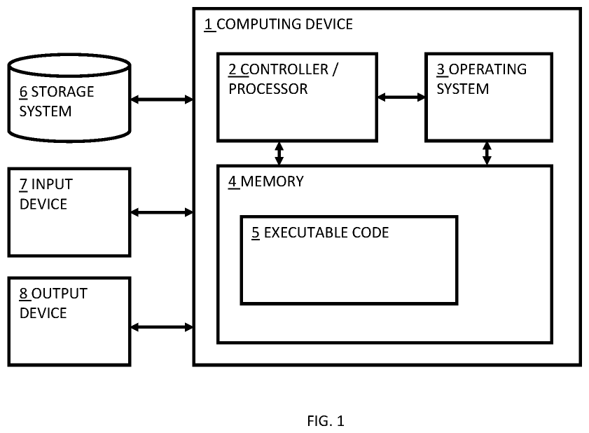

Reference is now made to FIG. 1, which is a block diagram depicting a computing device, which may be included within an embodiment of a system for detection and/or mitigation of CD using a BN, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7, and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling, or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may detect CD in a BN, and/or perform selective relearning of the BN, as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a Compact Disk-Recordable (CD-R) drive, a Blu-ray disk (BD), a universal serial bus (USB) device, or other suitable removable and/or fixed storage unit. Data pertaining to a BN, detection of CD in a BN and/or selective relearning of the BN may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse, and the like. Output devices 8 may include one or more (possibly detachable) displays or monitors, speakers and/or any other suitable output devices. Any applicable input/output (I/O) devices may be connected to computing device 1 as shown by blocks 7 and 8. For example, a wired or wireless network interface card (NIC), a universal serial bus (USB) device, or external hard drive may be included in input devices 7 and/or output devices 8. It will be recognized that any suitable number of input devices 7 and output device 8 may be operatively connected to computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

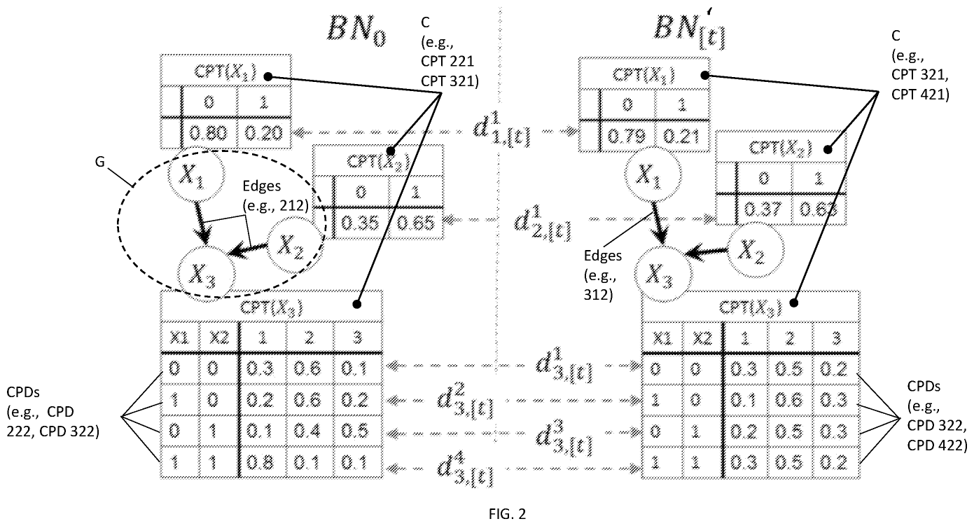

Reference is now made to FIG. 2, which is a schematic diagram depicting an example of a BN model, which may be analyzed and relearned according to some embodiments of the invention.

As shown in FIG. 2, a BN model (e.g., at time t=0) may have an initial configuration or version, denoted in FIG. 2 as BN₀. At some later time, t, data regarding domain variables of the BN model may be introduced into the BN model. To address the new data, which may represent the possibly drifted domain, the BN model may shift or change to a second configuration or version, denoted in FIG. 2 as configuration BN_{[t]}′ at time t.

As shown in FIG. 2, a BN model structure (denoted in FIG. 2 as ‘G’) may include a DAG over a set of random domain variables X={x₀, x₁, . . . , xₙ}, where each domain variable may be represented in the BN model by a respective node. In the example of FIG. 2, the number of nodes (and underlying domain variables) is 3. As nodes of the BN model may represent corresponding domain variables in an injective manner, naming and reference to nodes and corresponding domain variables may be used herein interchangeably. Additionally, BN model ‘G’ may include one or more edges (e.g., elements 212, 312) that may define a relation of causality between nodes (and underlying domain variables) of the BN.

As shown in FIG. 2, a BN model (e.g., BN₀) may also include a set of parameters (probabilistic relations denoted in FIG. 2 as ‘C’), corresponding to, or attributed to the DAG's nodes (and underlying domain variable). For example, the node-specific parameters C may include CPTs, where each CPT is associated with a node of the BN model. Each row in a node's CPT may hold a local (e.g., pertaining to the specific node) conditional probability distribution (CPD) for this node, given a certain configuration of its parent nodes in the graph.

As depicted in the example of FIG. 2, nodes x₁ and x₂ have no parents, and therefore the CPTs of these nodes each include a single CPD entry, describing a priori probability distribution of domain variables x₁ and x₂, respectively. For example, domain variable x₁ is a binary variable. In BN model BN₀, a probability of x₁ being assigned a ‘0’ value is 0.8, and a probability of x₁ being assigned a ‘1’ value is 0.2. Additionally, the node of domain variable x₃ is a child of parent nodes x₁ and x₂. The CPT of domain variable x₃ therefore includes four CPD entries, each corresponding to a single combination of values of parent domain variables x₁ and x₂.

In other words: (a) assuming discrete domain variables, a CPD may be multinomial; and (b) the number of CPD entries in a CPT of a specific node may equal the number of possible configurations of values of domain variables that correspond to parents of the specific node.

As known in the art, learning of a BN model may begin by learning the network structure G, e.g., building a DAG that represents relations of causality among nodes of the BN. Subsequently, learning of the BN may continue with learning the CPT parameters. While learning structure G is NP-hard, parameter C learning (e.g., by maximum likelihood estimation (MLE)) may be relatively easily solved, as known in the art.

Two BN models, BN₁ and BN₂ may be referred herein as equal (BN₁=BN₂) if and only if: (a) structure G₁ of BN₁ is identical to structure G₂ of BN₂ (e.g., all, and only the edges in G₁ appear in G₂, with the same orientations or directions), and (b) the learned or estimated parameters C₁ of BN₁ are not statistically different than the estimated or learned parameters C₂ of BN₂. Additionally, a BN model may be referred herein as stationary if BN_{[t]}=BN_{[t+L]} for each t and integer L.

Embodiments of the invention may detect CD at a specific time by independently estimating the CPTs of one or more (e.g., all) BN nodes. For example, embodiments of the invention may calculate the statistical distance between each CPD of a CPT estimated for the BN in the stable process (in-control) and the corresponding estimated distribution at the current time. Embodiments of the invention may subsequently apply a statistical process control (SPC) process to decide whether a distance is statistically unlikely (e.g., whether it is outside the process control limits), reflecting a change in the distribution of this CPD that demonstrates a CD.

Experimental results have shown several promising combinations of a CPT statistical distance function and an SPC function. As a default CPT statistical distance, the Pearson chi-square (CS) statistical distance was selected. As known in the art, the Pearson CS statistical distance may test whether an observed distribution (Q) is consistent with a hypothesized, expected distribution (P), as elaborated in Eq. 1, below:

$${D}_{C S} ( P , Q ) = {\sum }_{k = 1}^{K} \frac{{( {P}_{( k )} - {Q}_{( k )} )}^{2}}{{P}_{( k )}} \qquad Eq . 1$$

Where Dcs is the Pearson chi-square statistical distance;
Q is the observed distribution;
P is the expected distribution; and
k is an index of an observed value of the underlying variable, where k∈[1, K].

As a default SPC function, the exponentially weighted moving average (EWMA) function was selected. As known in the art, the EWMA function may compute a statistic to monitor a weighted average of the measurements, where the most recent CPT distance data element d[t] gets the greatest weight, as elaborated in Eq. 2, below:

Z_{[t]}=λ*d_{[t]}+(1−λ)*Z_{[t-1]} Eq. 2
where d[t] is the CPT distance data element of a current time or iteration;
Z[t] is the EWMA value for the current time or iteration;
Z[0] is the target EWMA value of the process (e.g., achieved when CPDs of consecutive iterations are identical);
and λ∈(0, 1) is a predefined smoothing parameter.

It may be appreciated that the lower control limit may remain 0, whereas the upper control limit (UCL) of the center line (CL) may be calculated according to Eq. 3, below:

$$U C L = C L + L * \hat{σ} * \sqrt{\frac{λ}{2 - λ}} \qquad Eq . 3$$

Where UCL is the upper control limit;
CL is the center line or mean of the CPT distance;
\hat{σ} is the estimated standard deviation of the CPT distance;
L is a predefined control parameter; and
λ∈(0, 1) is the predefined smoothing parameter.

Embodiments of the invention may employ Drift Detection by Parameter Monitoring (DDPM) to: (a) track the CPT statistical distance (e.g., by CS) using the SPC function (e.g., EWMA), and (b) relearning the BN using local re-learning (LRL).

Embodiments of the invention may apply parameter estimation, which is significantly inexpensive relative to structure learning, to identify changes in the network parameters or structure. A change in the network, e.g., BN inequality BN[t]!=BN[t+L] may indicates a loss of stationarity, e.g., CD. An initial BN, e.g., BN(t=0) may be learned during a stage of stability that may be assumed correct before any change occurs, and may serve as a baseline when measuring a CPD difference for any future learned BN, e.g., BN[t+L].

By assuming a fixed BN structure and estimating only the parameters using the latest available examples, embodiments of the invention may learn at time t a new BN, BN_{[t]}′, with the same structure, but with new parameter values or with a different structure. To test if BN₀=BN_{[t]}′, embodiments of the invention may measure distances between corresponding CPDs, as elaborated herein (e.g., in relation to FIG. 2).

For practical reasons, embodiments of the invention may determine two parameters: (a) a window size (W), which defines a quantity of the latest examples that should be used in order to learn the parameters of BN[t]′; and (b) a jump size (S), which is how often measurements should be taken. Although both the window size and jump size are measured according to their numbers of examples, they may reflect time elapsed during which these examples are made available to the analysis.

Since in practice, the CPD parameters are estimated using limited data, and variability is an inevitable component, one may not expect that every CPT distance that is greater than zero will correctly indicate a true CD. Hence, embodiments of the invention may monitor the BN stationarity, measured by parameter distances using the SPC chart that monitors the process variation to detect such a CD. Embodiments may keep the limits of the charts (UCL) fixed during monitoring to avoid missing slow and/or gradual changes that may occur and be sensitive to noise. Embodiments may assume these limits (e.g., UCL) are calculated based on historical data from which BN₀ is learned, or from a preliminary time frame in which no changes occur. Embodiments may also update the limits of the charts (e.g., UCL) dynamically to be more sensitive to latest changes and drifts than to old ones.

To identify which nodes (e.g., 211, 311) are involved in a change (e.g., undergoing CD), embodiments of the invention may monitor each node separately. When a node that has multiple CPDs (e.g., X₃ in FIG. 2) is monitored, embodiments may aggregate CPD difference metric values and monitor a single CPT or consider them multidimensionally.

According to some embodiments, aggregation of CPD difference metric values may be implemented as a weighted mean function, with weights wⱼ that may be equal to the proportions of parent configurations in the data where Σⱼ₌₁^{J}wⱼ=1.

Let d_{i,[t]}^{j} be the distance computed for node xᵢ at time t considering the jth CPD difference, relating to the j^{th} combination of values of parents of xᵢ. The CPT distance (e.g., the aggregated distance d_{i,[t]}^{A} of d_{i,[t]}^{j} over all parent configurations), may be calculated according to Eq. 4 below:

d_{i,[t]}^{A}=Σⱼ₌₁^{J}wⱼ*d_{i,[t]}^{j} Eq. 4

According to some embodiments, after learning network parameters (e.g., CPD parameters) with recent examples, and measuring and aggregating CPD distances, embodiments of the invention may obtain a CPT distance measurement per one or more (e.g., each) node of the BN. The CPT distance measurement may indicate, in relation to the relevant node, how far the BN model is at its current configuration or version from the initial (e.g., stable) or previous BN model.

According to some embodiments, one or more (e.g., all) node CPT distances may be monitored using the EWMA SPC function. If at least one CPT distance is higher than a control limit, a change may be alerted.

Embodiments of the invention may apply a local relearning (LRL) algorithm based on the information or alert that a node has been changed (and is therefore suspected of undergoing CD). The LRL algorithm may locally re-learn a new BN by considering for each suspected node a parametric change or a structural one. The structural change may include addition, removal, or reversal of an edge, without the need for re-learning the complete graph from scratch.

When considering a structural change, embodiments of the invention may search for an optimal BN structure within a space of available BN structures. For example, embodiments of the invention may start from BN0 and perform a finite number of search steps, where at each step, only local changes that can lead to neighboring DAGs may be considered. According to some embodiments, the LRL algorithm may be an iterative process, where in each iteration, the LRL algorithm may choose an optimal DAG that may result in the greatest improvement of a statistical score value (e.g., of a likelihood function or Kullback-Leibler (KL) divergence) compared with that of the previous optimal DAG. The iterative process may stop when there is no local change yielding such improvement.

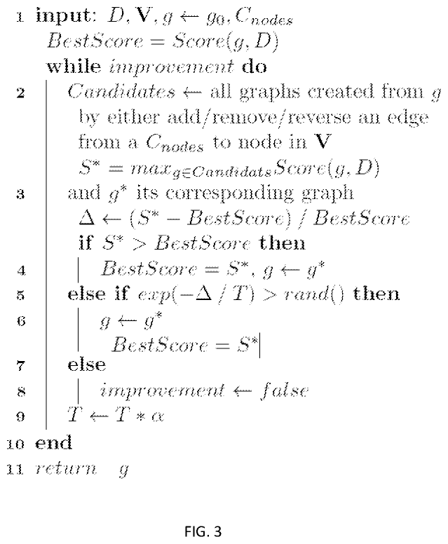

Reference is now made to FIG. 3, which depicts an example of pseudo-code for the LRL algorithm, according to some embodiments of the invention.

As shown in step 1 of the pseudo-code example of FIG. 3, the input to the LRL algorithm may include: (a) a dataset (D) that may be defined over a set of domain variables V={x₀, x₁, . . . , xₙ}; (b) g₀, an initial BN structure or DAG (such as BN₀ of FIG. 2) that may be defined over V, and may be used as a starting point for the search (e.g., the iterative LRL algorithm); and (c) Cnodes: one or more nodes (e.g., 211) that may have been identified as changed (e.g., suspected as undergoing CD).

As shown in step 2 of the pseudo-code example, at each iteration, a list of candidate DAGs may be created by applying a single structural change to a current DAG in relation to a suspected node. For example, the structural changes may include removing, adding, or reversing an edge from/to/of a node which was identified as changed (e.g., a node of Cnodes), and is therefore suspected as undergoing CD. The DAGs may be created while avoiding possible cycles.

According to some embodiments, the LRL algorithm may calculate, for one or more candidate DAGs, a statistical score that may represent a likelihood that the relevant DAG corresponds to the incoming data D. It may be appreciated that the LRL algorithm may not be limited to any specific scoring function. As a non-limiting example, the LRL algorithm may use a Bayesian Dirichlet with likelihood equivalence and a uniform joint distribution, as known in the art.

According to some embodiments, the LRL algorithm may select an optimal DAG based on a simulated annealing scheme. In other words: if g* (e.g., a DAG resulting in the maximum statistical score among the candidate graphs) improves the existing DAG's statistical score, then it is always selected. Otherwise, the LRL algorithm may select a DAG corresponding to an inferior score with some selection probability that is less than 1. According to some embodiments, the selection probability may decrease exponentially with the poorness of the graph score, which is the amount Δ by which the solution is worsened. In each iteration, the best score (e.g., BestScore) is updated.

Without limiting the generality, we initialized two parameters: T (temperature) and α (a constant relating temperature to energy) using T=0.025 and α=0.5.

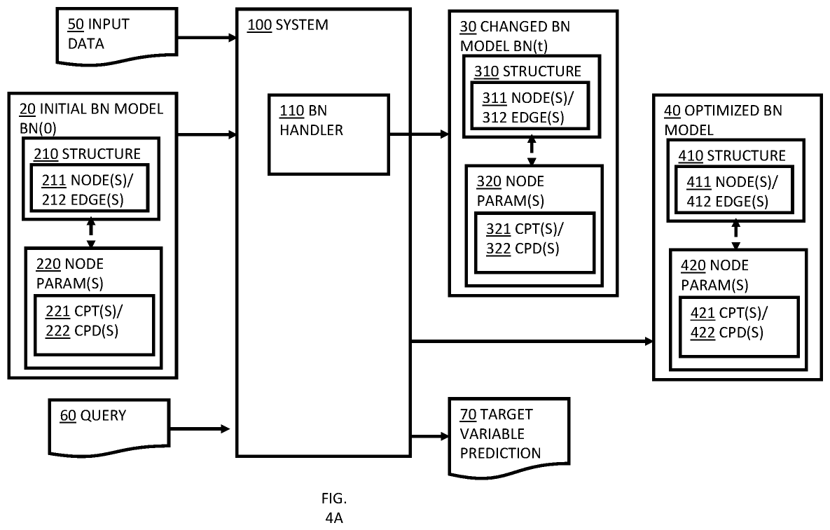

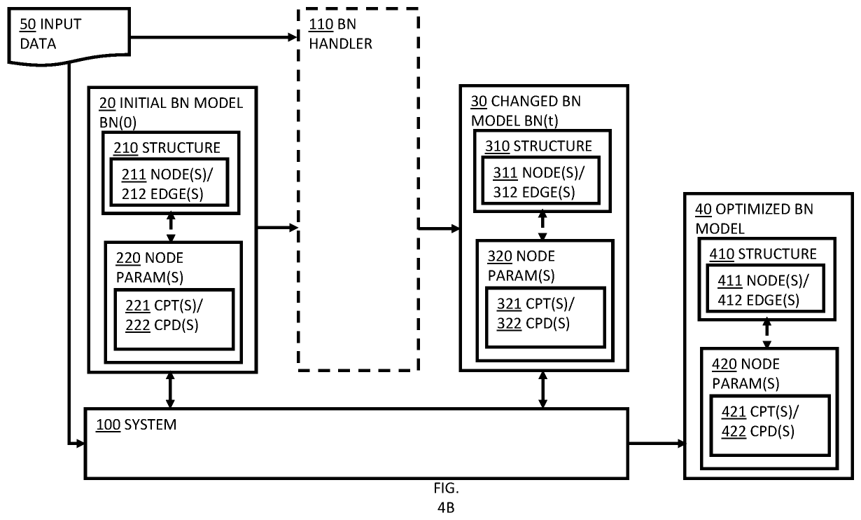

Reference is now made to FIGS. 4A and 4B, which are block diagrams depicting embodiments of a system 100 for detecting and/or mitigating CD in a BN, according to some embodiments of the invention.

According to some embodiments of the invention, system 100 may be implemented as a software module, a hardware module, or any combination thereof. For example, system 100 may be or may include a computing device such as element 1 of FIG. 1, and may be adapted to execute one or more modules of executable code (e.g., element 5 of FIG. 1) to detect and/or mitigate CD in a BN, as described herein.

As shown in FIGS. 4A and 4B, arrows may represent flow of one or more data elements to and from system 100 and/or among modules or elements of system 100. Some arrows have been omitted in FIGS. 4A and 4B for the purpose of clarity.

As shown in FIG. 4A, system 100 may include a BN handler module 110. BN handler module 110 may be adapted to receive a first version of a BN model, denoted in FIG. 4A as “initial BN model BN(0)” element 20. BN model 20 may include a plurality of interconnected nodes 211. Each node 211 may correspond to a specific domain variable, and may include, or may be attributed or associated with a conditional probability table (CPT) 221. CPT 221 may represent statistic characteristics or parameters of the corresponding domain variable as elaborated herein (e.g., in relation to FIG. 2).

According to some embodiments, BN handler module 110 may receive incoming input data 50, such as an incoming data stream. Input data 50 may include, for example, examples with values of domain variables that are represented by nodes 211 of BN 20. BN handler module 110 may compute or update, based on incoming data stream 50, at least one CPT value of at least one (e.g., all) node 211 that is included in the first version 20 of the BN model. BN handler module 110 may thus produce a second version of CPT 221, denoted in FIG. 4A as CPT 321. CPT 321 may represent, or be included in a second version of the BN, denoted in FIG. 4A as element 30. In other words, BN handler module 110 may transit a BN from a first state or version 20 to a second state or version 30, based on input data 50, as known in the art.

According to some embodiments, and as shown in FIG. 4B, system 100 may be implemented on a computing device other than BN handler module 110. In such embodiments, system 100 may receive a first version or state 20 of a BN, and a second version or state 30 of the BN (e.g., from a third-party BN handler module 110).

According to some embodiments, system 100 may identify at least one node of the BN as suspected of undergoing CD based on the CPT 221 values and CPT 321 values, and may produce an optimized BN model 40, to mitigate effect of the suspected CD, as elaborated herein.

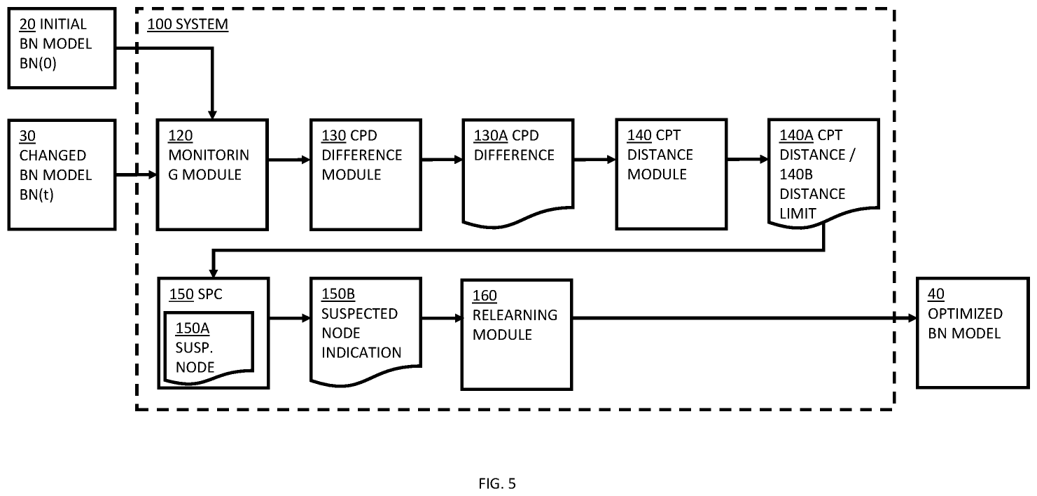

Reference is now made to FIG. 5, which is a block diagram depicting modules of system 100 for detecting and/or mitigating CD using a BN, according to some embodiments of the invention. System 100 may be or may include the same system 100 as depicted in FIG. 4A and/or FIG. 4B.

As known in the art, a BN handler module 110 (e.g., included in system 100, as in FIG. 4A, or associated with system 100, as in FIG. 4B) may continuously update a BN model based on incoming data. For example, BN handler module 110 may initially produce version 30 of a BN model from an initial version 20 of the BN model, based on incoming data 50. Subsequently, BN handler module 110 may relate to the new version 30 of the BN model as an original BN model 20, and produce a subsequent new version 30 of the BN model, based on new incoming data 50.

As shown in FIG. 5, system 100 may include a monitoring module 120, adapted to monitor CPTs 321 of BN model 30, to identify at least one change in a value of CPTs 321. For example, this change may be between CPT 321 of node 311 of version 30 and CPT 221 of node 211 of version 20 of the BN model. In another example, this change may be between subsequent versions of CPT 321, e.g., of different versions 30 of the BNs learned in subsequent iterations or time points.

As elaborated herein (e.g., in relation to FIG. 2), CPT 321 of at least one first node may include one or more CPD entries (e.g., 322). Each CPD entry may represent probabilities of domain variable values of the first node conditioned on values of domain variables that are represented by one or more parent nodes of the first node. In the example of FIG. 2, CPD entries of node x₃ include conditional probability distributions for four configurations of parent nodes x₁ and x₂.

According to some embodiments, system 100 may calculate a CPT distance 140A value of a specific node 311, based on the CPD entries of that node, as elaborated herein.

As shown in FIG. 5, system 100 may include a CPD difference module 130 which may receive, e.g., from monitoring module 120, an indication of at least one change in a value of at least one parameter 320 (e.g., 321, 322) of a node 311 of the BN. This indication may, for example, include a change in a value of CPT 321 and/or values of CPD 322 of node 311 of the BN model.

According to some embodiments, CPD difference module 130 may calculate one or more CPD difference metric values 130A between at least one CPD of a first CPT (e.g., of version 20 of the BN model) and at least one corresponding CPD of a second CPT (e.g., of version 30 of the BN model). For example, as depicted in FIG. 2, CPD difference module 130 may compute four difference metric values 130A, denoted in FIG. 2 as elements d¹_{3,[t]}, d²_{3,[t]}, d³_{3,[t]}, and d⁴_{3,[t]}, in relation to the CPT 321 of node x₃. In this example: (a) the lower index (e.g., 3) represents a serial number of the node (x₃, in this case), (b) the upper index (e.g., 1, 2, 3 and 4) represents an index of the CPD within the specific CPT in relation to a configuration of the node's parents (e.g., the CPT of node x₃), and (c) the notation [t] indicates a difference metric value 130A that was calculated between a current version (e.g., 20 and/or 30) of the BN and a subsequent version 30 of the BN at time ‘t’.

According to some embodiments, CPD difference module 130 may use, or may employ one or more appropriate algorithms for obtaining CPD difference metrics 130A. For example, CPD difference module 130 may use a total variation (TV) algorithm, as elaborated herein, to produce a CPD difference metric 130A that is a TV difference metric. In another example, CPD difference module 130 may use a Pearson chi-square statistic (CS) algorithm, as elaborated herein, to produce a CPD difference metric 130A that is a CS difference metric. In another example, CPD difference module 130 may use a KL divergence distance algorithm, as elaborated herein, to produce a CPD difference metric 130A that is a KL divergence difference metric. In yet another example, CPD difference module 130 may use a Hellinger distance algorithm, as elaborated herein, to produce a CPD difference metric 130A that is a Hellinger distance.

For example, let P and Q be two multinomial distributions (CPDs) over the same set of K variable values. A TV distance may measure the sum of absolute differences between P and Q, according to Eq. 5 below:

$${D}_{T V} ( P , Q ) = \frac{1}{2} {\sum }_{k = 1}^{K} \vert {P}_{( k )} - {Q}_{( k )} \vert \qquad Eq . 5$$

In another example, a CS may test whether the observed distribution (Q) is consistent with a hypothesized, expected distribution (P), according to Eq. 6 below:

$${D}_{CS} ( P , Q ) = {\sum }_{k = 1}^{K} \frac{{( {P}_{( k )} - {Q}_{( k )} )}^{2}}{{P}_{( k )}} \qquad Eq . 6$$

In another example, a KL divergence may measure the divergence of in-use distribution Q from the real distribution P, according to Eq. 7 below:

$${D}_{K L} ( P , Q ) = {\sum }_{k = 1}^{K} {P}_{( k )} ln \frac{{P}_{( k )}}{{Q}_{( k )}} \qquad Eq . 7$$

In yet another example, Hellinger distance (H) may be based on the Bhattacharyya coefficient and may be calculated according to Eq. 8 below:

$${D}_{H} ( P , Q ) = {( 1 - {\sum }_{k = 1}^{K} {( {P}_{( k )} * {Q}_{( k )} )}^{1 / 2} )}^{1 / 2} \qquad Eq . 8$$

As shown in FIG. 5, system 100 may include a CPT distance module 140, adapted to calculate a CPT distance 140A between a first CPT and a second CPT. Pertaining to the example depicted in FIG. 2, CPT distance module 140 may calculate a CPT distance 140A, representing a distance between two CPTs of a specific node, corresponding to two respective versions (e.g., 20, 30) of the BN. According to some embodiments, CPT distance module 140 may calculate CPT distance 140A based on CPD difference metric values 130A between the CPDs of a first CPT and the CPDs of a second CPT, e.g., as denoted by elements d¹_{3,[t]}, d²_{3,[t]}, d³_{3,[t]}, and d⁴_{3,[t]} of FIG. 2. According to some embodiments, CPT distance module 140 may calculate a CPT distance 140A as a function of the one or more CPD difference metric values 130A. For example, CPT distance module 140 may calculate a CPT distance 140A as a weighted sum of CPD difference 130A metric values or multidimensionally over all values.

According to some embodiments, CPT distance module 140 may calculate, for at least one node 311 of the BN, a distance limit or threshold value 140B, based on the CPT 321 of that node 311. For example, CPT distance module 140 may measure CPT distance value 140A every predefined period of time during a stable (e.g., “in-control”) or a previous condition, and use a plurality of such measurements, taken at respective, different time points during the stable or previous period, to calculate the mean (e.g., ‘N’) and standard deviation (e.g., ‘STD-DEV’) of distance value 140A during the stable (e.g., “in-control”) condition. CPT distance module 140 may then compute distance limit 140B based on the calculated mean (‘N’) and standard deviation (‘STD-DEV’) of distance value 140A. For example, CPT distance module 140 may calculate distance limit 140B as an upper control limit, according to Eq. 9 below:

Distance_limit=N+α·STD-DEV Eq. 9
where Distance_limit is distance limit 140B;
N is the calculated mean of distance value 140A;
STD-DEV is the calculated standard deviation of distance value 140A; and
α is a predefined parameter.

According to some embodiments, system 100 may include an SPC module 150, configured to identify at least one suspected node 150A of the BN as undergoing CD, based on the at least one calculated CPT distance values, as elaborated herein.

SPC module 150 may continuously monitor the CPT distance value 140A of the at least one node 311 in relation to distance limit or threshold value 140B to determine whether the relevant node 311 is suspected of undergoing CD. The term “continuous” may be used in this context to indicate repetition over time, e.g., following elapse of a predefined period, and/or occurrence of an event (e.g., introduction of data 50). SPC module 150 may subsequently analyze the sampled CPT distance value 140A of relevant node 311 in view of distance limit value 140B of that node to determine whether node 311 has undergone CD.

According to some embodiments, SPC module 150 may analyze the monitored CPT distance value 140A in relation to the calculated distance limit value 140B by applying an SPC analysis algorithm to determine whether the at least one calculated CPT distance value represents CD as elaborated herein. SPC module 150 may subsequently identify at least one node 311 as a suspected node 150A based on the SPC analysis algorithm, and may produce a respective indication 150B of the relevant node 311 as being suspected of undergoing CD. This indication is denoted “Suspected node indication 150B” in FIG. 5.

According to some embodiments, SPC module 150 may analyze the at least one CPT distance value 140A in view of the calculated distance limit value 140B to identify the at least one node 311 as suspected of undergoing CD. For example, SPC module 150 may analyze the at least one CPT distance value 140A in view of the calculated distance limit value 140B using an SPC algorithm such as the Shewhart chart, Exponentially Weighted Moving Average (EWMA) chart, multivariate EWMA (MEWMA) chart, and Hotelling T² chart, as elaborated herein.

According to some embodiments, SPC module 150 may apply statistical process control methodology to monitor the measured CPT statistical distances 140A over time. Since a target CPT statistical distance value 140A (denoted herein as CL) may be set at zero, the CPT statistical distance 140A may be bounded below by zero. Hence, a lower limit for CPT statistical distance value 140A may be discarded, and only an upper control limit (UCL) value may be calculated.

Let d_{[t]} be the t^{th} measurement of the monitored CPD difference 130A, and be the standard deviation calculated using T measurements from a stable or previous process. Embodiments of the invention may consider a variety of SPC charts.

For example, the SPC algorithm may be the Shewhart Control Chart. In this example, UCL may be calculated based on a distance of a predefined number (e.g., three) standard deviations from the target value, according to Eq. 10 below:

UCL=CL+3*\hat{σ} Eq. 10

In another example, the SPC algorithm may be the Exponentially Weighted Moving Average (EWMA) Chart, which may monitor a weighted average of the measurements, such that the most recent one gets the greatest weight. EWMA is calculated as elaborated in Eq. 2, and UCL is calculated as elaborated in Eq. 3.

It may be noted that both the Shewhart and EWMA charts are designed for univariate monitoring, meaning a single measure at a time. The following SPC charts are extensions of these two, designed to monitor multiple variables jointly. Let d_{[t]} denote the multivariate measurement vector at time t with J values, J=|d_{[t]}|, and d̅ and S the measurements mean vector and covariance matrix, respectively.

For example, the SPC algorithm may be a Hotelling T² Control Chart, which is the multivariate version of the Shewhart chart, and may measure the Mahalanobis distance of d_{[t]} from d̅. The T² statistic is calculated according to Eq. 11 below:

T²_{[t]}=(d_{[t]}−d̅)′S⁻¹(d_{[t]}−d̅) Eq. 11

Where S is defined according to Eq. 12, below:

$$S = \frac{1}{T - 1} {\sum }_{t = 1}^{T} ( {d}_{[ t ]} - \overline{d} ) {( {d}_{[ t ]} - \overline{d} )}^{′} \qquad Eq . 12$$

and the UCL is calculated according to Eq. 13, below:

$$U C L = \frac{J ( T + 1 ) ( T - 1 )}{{T}^{2} - TJ} {F}_{α , J , T - J}$$

where F_{α,J,T-J} is the (1−α)^{th} quantile of the F_{J,T-J} distribution.

In another example, the SPC algorithm may be a Multivariate EWMA (MEWMA) chart, which is the multivariate version of EWMA, where:
(a) Z_{[t]} is the average of d_{[t]}, as elaborated in Eq. 2 and
The statistic T²is calculated according to Eq. 13, below:

T²_{[t]}=Z′_{[t]}S_{Z(t)}⁻¹Z_{[t]} Eq. 13

where S_{Z(t)} is calculated according to Eq. 14 below:

$${S}_{Z ( t )} = \frac{λ}{2 - λ} [ 1 - {( 1 - λ )}^{2 t} ] S \qquad Eq . 14$$

And where S is calculated according to Eq. 15 below:

$$S = \frac{1}{T - 1} {\sum }_{t = 1}^{T} ( {d}_{[ t ]} - \overline{d} ) {( {d}_{[ t ]} - \overline{d} )}^{′} \qquad Eq . 15$$

As shown in FIG. 5, system 100 may include a relearning module 160, adapted to locally relearn or retrain a portion of the BN structure 310, based on the suspected node indication 150B, so as to produce an optimized BN model 40, as elaborated herein. BN model 40 may be “optimized” in a sense that a structure 410 of BN model 40 may be optimally selected, as elaborated herein, to mitigate the effect of CD of one or more domain variables of the BN.

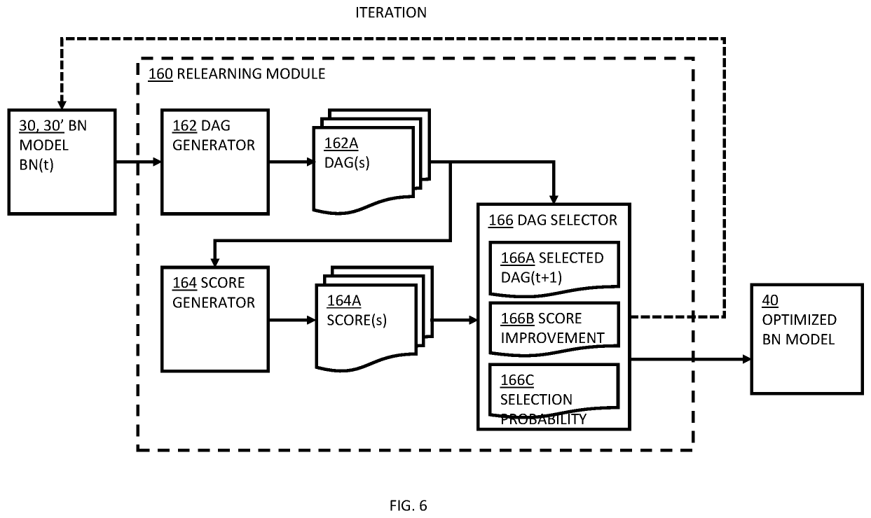

Reference is now made to FIG. 6, which is a block diagram depicting components of a relearning module 160, which may be included in system 100 for detecting and/or mitigating CD in a BN, according to some embodiments of the invention.

As shown in FIG. 6, relearning module 160 may include a DAG generator module 162, adapted to generate or produce a plurality of DAGs 162A that includes structure 310 elements of the BN (e.g., of state or version 30 of the BN). For example, each DAG may include nodes 311 of version 30 of the BN and one or more edges 312 of version 30 of the BN.

According to some embodiments, each DAG 162A may represent a single structural change in the BN, in relation to (a) a version 30 of the BN and (b) at least one suspected node. For example, relearning module 160 may receive (e.g., from SPC module 150, as depicted in FIG. 5) an indication 150B of a suspected node 311. DAG generator module 162 may produce one or more (e.g., a plurality) of DAGs 162A, each having the same nodes 311 and edges 312 as structure 310 of version 30 of the BN, expect for a single structural change due to a single suspected node 311.

According to some embodiments, the single structural change may include, for example, addition of an edge 312, omission of an edge 312, and reversal of an edge 312. Pertaining to the example of FIG. 2, addition of an edge 312 may include for example addition of an edge from x₁ to x₂ in BN_{[t]}, indicating a relation of causality between these nodes. In the same example of FIG. 2, omission of an edge 312 may include omission of the edge connecting nodes x₁ and x₃, indicating severance of the relation of causality between these nodes. In the same example of FIG. 2, reversal of an edge 312 may include reversal of the edge that connects nodes x₂ and x₃, thus indicating a reversed relation of causality between these nodes (e.g., where x₃ is now a parent of x₂).

According to some embodiments, DAG generator 162 may apply appropriate adjustments to one or more nodes 311, edges 312, and CPTs 321 of the BN to reflect the structural changes. For example, when the single structural change includes omission of an edge 312, such as the edge connecting nodes x₁ and x₃, DAG generator 162 may update CPT 321 (and underlying CPD 322 values) of node 311 x₃ to reflect that change (e.g., that x₃ is dependent on x₂, but not on x₁). In another example, when the single structural change includes addition of an edge 312, such as an edge connecting x₁ to x₂, DAG generator 162 may update CPT 321 (and underlying CPD 322 values) of node 311 x₂ to reflect that change (e.g., that x₂ is now dependent on x₁). In yet another example, when the single structural change includes reversal of an edge 312, such as reversal of the edge that connects nodes x₂ and x₃, DAG generator 162 may (a) update CPT 321 (and underlying CPD 322 values) of node 311 x₂ to indicate the dependence of x₂ on x₃, and (b) update CPT 321 (and underlying CPD 322 values) of node 311 x₃ to indicate x₃ independence of x₂.

As shown in FIG. 6, relearning module 160 may include a score generator module 164, configured to calculate for one or more (e.g., each) DAG 162A a statistical score 164A. Statistical score 164A may, for example, represent a likelihood that the relevant DAG corresponds to the incoming data stream.

According to some embodiments, score generator module 164 may calculate statistical score 164A of a DAG 162A based on CPDs of nodes 311 of the DAG 162A.

For example, statistical score 164A may be calculated based on CPT values (e.g., as shown in the example of FIG. 2) as a K2 score, a Bayesian Dirichlet (BD) score, a Bayesian Dirichlet equivalent (BDe) score, a Bayesian Dirichlet with likelihood equivalence and a uniform joint distribution (BDeu) score, a KL score, and any other appropriate likelihood score as known in the art.

As shown in FIG. 6, relearning module 160 may include a DAG selector module 166, adapted to select a DAG 166A among the plurality of DAGs, based on the calculated statistical scores 164A. For example, DAG selector module 166 may be configured to select, from the plurality of DAGs 162A, a selected DAG 166A that corresponds to a maximal statistical score 164A. DAG selector module 166 may subsequently produce optimized version 40 of the BN, based on the selected DAG.

For example, DAG selector module 166 may produce an optimized version 40 of BN model that may be identical in structure 310 (e.g., nodes 311 and edges 312) and parameters 320 (e.g., CPT 321 values and CPD 322 values) to version 30 of the BN, except for changes that are derived from at least one (e.g., single) structural change, as reflected by the selected DAG 166A. For example, if selected DAG 166A corresponds to a single structural change that is an omission of an edge, then optimized version 40 of BN model may be identical to version 30 of the BN, except for: (a) the relevant edge in optimized version 40 may be omitted, and (b) CPT 321 values (and underlying CPD values 322) of the relevant node 311 may be updated to indicate the edge-omission change.

According to some embodiments, the selection of a DAG and subsequent selection of an optimal version 40 of the BN may be an iterative process. In other words, the local relearning process, performed by relearning module 160 may be an iterative process, where each iteration comprises selecting an optimal DAG, representing a single structural change in the BN in relation to the previous iteration. This iterative process may continue with better DAGs, as long as statistical score 164A improves between iterations.

In other words, relearning module 160 may perform the local relearning process as an iterative search process, in which an optimal DAG is selected.

In each iteration of the local relearning process DAG generator 162 may produce a plurality of DAGs 162A, where each DAG 162A may represent a single structural change in the BN in relation to a previous iteration. Score generator 164 may produce a plurality of statistical scores 164A corresponding to the plurality of DAGs 162A. DAG selector 166 may then select an optimal DAG 166A, among the plurality of DAGs 162A, based on the calculated statistical scores. The selected DAG may then be used as a basis for further optimization of the BN structure, in a subsequent iteration (e.g., marked (t+1)), as shown by the dashed arrow of FIG. 6.

According to some embodiments, DAG selector 166 may calculate an improvement of the statistical score (e.g., score improvement 166B of FIG. 6) of the selected DAG 166A in a current iteration, in relation to the statistical score of a selected DAG of the previous iteration. Relearning module 160 may subsequently repeat the iterative process, with the selected optimal DAG (e.g., selected DAG 166A of the next iteration, (t+1)) based on the calculated improvement.

For example, relearning module 160 may repeat the iterative process as long as the statistical score 164A of the selected DAG improves between iterations.

In another example, relearning module 160 may repeat the iterative relearning process as long as the statistical score 164A of the selected DAG improves between iterations beyond a predefined threshold.

Additionally or alternatively, the iterative process may be conducted according to a simulated annealing scheme, as known in the art. In such embodiments, the iterative local relearning process may continue, while selecting DAGs that are associated with inferior (e.g., not higher) statistical scores 164A in relation to previous iterations. Such selection of inferior (e.g., not higher) score DAGs may be allowed with higher chances early in the search and lower chances later in the search. It may be appreciated that such a simulated annealing scheme may allow the iterative process search to move toward a global solution, rather than converging to a local solution.

As depicted in FIG. 6, in a first iteration, relearning module 160 may receive a first version 30 of BN model, and perform a first iteration of selection of a DAG 166A to generate a first version of optimized BN model. This first version of optimized BN model is denoted by element 30′ in FIG. 6, and may include a single structural change in relation to version 30 of the BN. In a second, subsequent iteration, relearning module 160 may receive a version 30′ of BN model as input, and obtain a second version of optimized BN model, which may include a single structural change in relation to version 30′ of the BN. This iterative process may continue with better DAGs, as long as the statistical score 164A improves.

According to some embodiments, an optimal, selected DAG 166A of a current iteration (e.g., t) may be associated with a current statistical score 164A, and an optimal, selected DAG of a previous iteration (e.g., (t−1)) may be associated with a previous, not inferior (e.g., higher) statistical score. DAG selector 166 may calculate a selection probability 166C according to: (a) a number or index of a current iteration (e.g., t), (b) the current highest statistical score 164A, (c) the previous highest statistical score 164A, and (d) a random decision threshold to which the normalized difference between the two scores is compared, as shown in lines 3 and 5 of the pseudo-code for the LRL algorithm in FIG. 3. DAG selector module 166 may select the DAG of the current iteration (e.g., t) based on selection probability 166C. In such embodiments, DAG selector 166 may select an optimal DAG 166A for the next iteration based on a simulated annealing scheme, where a poorer (e.g., not higher scored) DAG (e.g., the optimal, selected DAG 166A of the current iteration) may be selected over an equivalent score or a superior score DAG (e.g., the optimal, selected DAG 166A of the previous iteration), according to the calculated selection probability 166C.

According to some embodiments, a poorer DAG may be selected with higher chances early in the iterative search process, and with lower chances later in the search. For example, selection probability 166C may be calculated such that for each pair of consecutive iterations (e.g., t, (t+1)) of the local relearning process, the score 164A of the DAG in a first iteration (e.g., t) of the pair of iterations is higher than the score 164A of the DAG in a second, later iteration (e.g., (t+1)) of the pair of iterations.

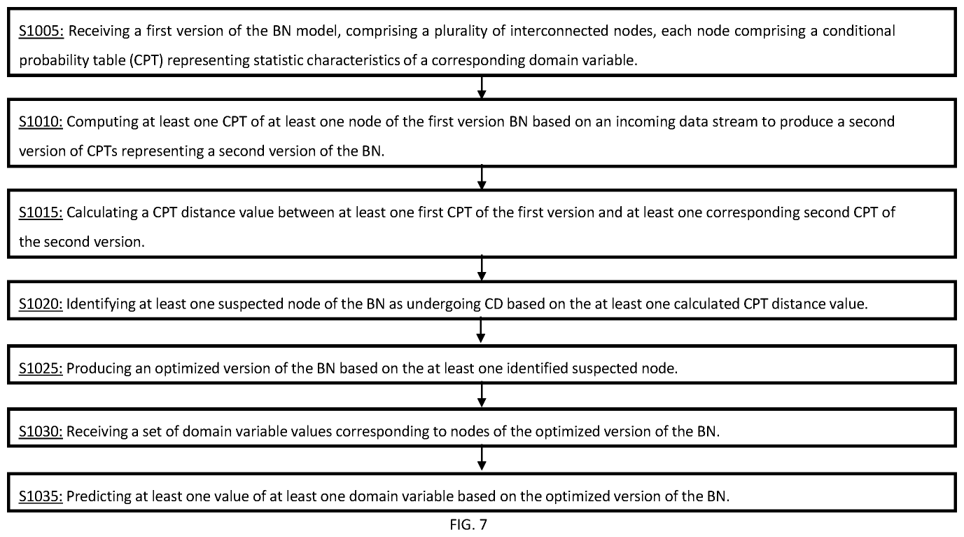

Reference is now made to FIG. 7, which is a flow diagram depicting a method for detecting and/or mitigating CD using a BN by at least one processor (e.g., processor 2 of FIG. 1), according to some embodiments of the invention.

As shown in step S1005, processor 2 may receive a first version (e.g., element 20 of FIG. 4A) of the BN model (e.g., BN(0)) that may include a plurality of nodes 211. Each node may represent a domain variable and may be interconnected by edges 212 that may represent relations of causality between respective domain variables.

Each node 211 may be, or may include a data structure that may include, or may be associated with a CPT (e.g., element 221 of FIG. 4A). Each CPT 221 may represent statistical characteristics of a corresponding domain variable. For example, CPT 221 may represent conditional probabilities between a domain variable of a child node 211 and one or more domain variables of corresponding to its parent nodes 211.

As shown in step S1010, processor 2 may compute at least one CPT 221 of at least one node of the first version BN based on an incoming data stream to produce a second version of CPTs 321 representing a second version (e.g., element 30 of FIG. 4A) of the BN. Additionally, or alternatively, processor 2 may receive CPTs 221 and 321 (e.g., of versions 20 and 30 respectively) from a third-party computing device (e.g., BN handler element 110 of FIG. 4B).

As shown in step S1015, processor 2 may calculate a CPT distance value (e.g., CPT distance 140A of FIG. 5) between at least one first CPT (e.g., 221, 321) of a node (e.g., 211, 311) of the first version (e.g., 20, 30) and at least one corresponding second CPT (e.g., 321) of the node (e.g., 311) of the second version 30.

As shown in step S1020, processor 2 may identify at least one suspected node (e.g., element 150A of FIG. 5) of the BN as undergoing CD based on the at least one calculated CPT distance value 140A, as elaborated herein (e.g., in relation to FIG. 5).

As shown in step S1025, processor 2 may produce an optimized version 40 of the BN based on the at least one identified suspected node 150A, in an iterative relearning process, as elaborated herein (e.g., in relation to FIG. 6). Processor 2 may subsequently utilize the optimized version 40 of the BN model to predict one or more domain variables (e.g., target domain variables or non-target domain variables) based on the optimized version 40 of the BN.

For example, and as shown in steps S1030 and S1035, processor 2 may receive as input (e.g., input 50 of FIG. 4A and/or FIG. 4B) a set of domain variable values, corresponding to nodes of the optimized version 40 of the BN, and may predict at least one value of at least one domain variable, corresponding to a node 411 of the BN, based on the optimized version 40 of the BN.

Embodiments of the invention may include a practical application of ML-based models, such as BN models, on incoming data.

For example, embodiments of the invention may generate an optimized version 40 of a BN, based on the at least one identified suspected node 311, as elaborated herein (e.g., in relation to FIG. 6).

According to some embodiments, System 100 may receive (e.g., at an inference stage) a set of domain variable values, corresponding to nodes 411 of the optimized version 40 of the BN. System 100 may also receive (e.g., from input device 7 of FIG. 1) a query (e.g., query 60 of FIG. 4A) for an unknown value of at least one domain variable that may be represented by a node 411 of the optimized version 40 of the BN. System 100 may thus predict (e.g., prediction 70 of FIG. 4A) or retrieve the value of the at least one target variable, based on the optimized version 40 of the BN, as known in the art.

As elaborated herein, embodiments of the invention may dynamically and efficiently mitigate an effect of concept drift in at least one domain variable, and accurately predict a value of at least one target or non-target domain variable represented by a node of the BN.

The term “accurately” may be used in this context to indicate optimal selection of a BN model to best reflect statistical relations among domain variables, which may represent, for example, “real-world” variables and conditions. In other words, embodiments of the invention may mitigate an effect of CD in one or more domain variables on a BN model to accurately represent real-world processes and conditions and to accurately predict an unknown value of a domain variable. The term “efficiently” may be used in this context to indicate that structural relearning of the BN model may be done locally, in relation to specific, suspected nodes of the BN. In other words, embodiments of the invention may provide an improvement in computer function over currently available methods and systems that may require relearning or retraining of an entire ML-based model. The term “dynamically” may be used in this context to indicate that embodiments of the invention may mitigate conditions of CD that are manifested in incoming, streaming data, due to the efficient relearning process, as elaborated herein. In other words, embodiments of the invention may provide an improvement in computer function over currently available methods and systems that may not be able to scale-up BN relearning, due to an inefficient relearning process.

Unless explicitly stated, the method embodiments described herein are not constrained to a particular order or sequence. Furthermore, all equations described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of detecting, by at least one processor, Concept Drift (CD) using a Bayesian Network (BN) model, the method comprising:
receiving a first version of the BN model, comprising a plurality of interconnected nodes, each node comprising a conditional probability table (CPT) representing statistic characteristics of a corresponding domain variable;
computing at least one CPT of at least one node of the first version BN based on an incoming data stream to produce a second version of CPTs representing a second version of the BN;
calculating a CPT distance value between at least one first CPT of the first version and at least one corresponding second CPT of the second version; and
identifying at least one suspected node of the BN as undergoing CD based on the at least one calculated CPT distance value.

2. The method of claim 1, wherein the CPT of at least one first node comprises one or more conditional probability distribution (CPD) entries, and wherein each CPD entry represents probabilities of domain variable values of the first node conditioned on values of domain variables that are represented by one or more parent nodes of the first node.

3. The method of claim 2, wherein calculating the CPT distance between the first CPT and the second CPT comprises:
calculating one or more CPD difference metric values between the CPDs of the first CPT and the CPDs of the second CPT; and
calculating the CPT distance as a function of the one or more CPD difference metric values.

4. The method of claim 3, wherein the function is selected from a list consisting of the Shewhart control or Exponentially Weighted Moving Average (EWMA) charts applied to the weighted sum of CPD difference metric values or the multivariate EWMA (MEWMA) or Hotelling T² charts applied to the concatenation of the CPD difference metric values.

5. The method claim 3, wherein the CPD difference metrics are selected from a list consisting of: Total Variation (TV) distance, Pearson Chi-square Statistic (CS) test, Kullback-Leibler (KL) Divergence, and Hellinger distance.

6. The method of claim 1, wherein identifying at least one suspected node comprises applying statistical process control (SPC) to determine whether the at least one calculated CPT distance value represents CD.

7. The method of claim 1, wherein identifying at least one suspected node comprises:
monitoring at least one CPT distance value of the at least one node;
calculating, for at least one node, a distance limit value based on the CPT distance of that node;
analyzing the monitored CPT distance value in relation to the calculated distance limit value; and
identifying the at least one node as suspected of undergoing CD based on the analysis.

8. The method of claim 7, wherein analyzing the at least one CPT distance value comprises applying an SPC algorithm on the monitored at least one CPT distance value and the distance limit value, to identify the at least one node as suspected of undergoing CD, wherein said SPC algorithm is selected from a list consisting of: the Shewhart chart, Exponentially Weighted Moving Average (EWMA) chart, multivariate EWMA (MEWMA) chart, and Hotelling T² chart.

9. The method of claim 7, further comprising determining the distance limit value dynamically based on the monitored CPT distance values.

10. The method of claim 1, further comprising:
producing an optimized version of the BN based on the at least one identified suspected node;
receiving a set of domain variable values corresponding to nodes of the optimized version of the BN; and
predicting at least one value of at least one domain variable based on the optimized version of the BN.

11. The method of claim 1, further comprising a local relearning process, said process comprising:
producing a plurality of Directed Acyclic Graphs (DAGs), wherein each DAG comprises nodes of the BN, and represents a single structural change in the BN in relation to at least one suspected node;
for each DAG of the plurality of DAGs, calculating a statistical score, representing a likelihood that the DAG corresponds to the incoming data stream;
selecting a DAG among the plurality of DAGs based on the calculated statistical scores; and
producing an optimized version of the BN based on the selected DAG.

12. The method of claim 11, wherein the local relearning process is an iterative process, wherein each iteration comprises:
producing a plurality of DAGs;
selecting an optimal DAG, representing a single structural change in the BN in relation to a previous iteration, based on the calculated statistical scores;
calculating an improvement of the statistical score of the selected DAG in relation to the statistical score of a selected DAG of the previous iteration; and
repeating the iterative process, with the selected optimal DAG based on the calculated improvement.

13. The method of claim 12, further comprising repeating the iterative process as long as the statistical score of the selected DAG improves beyond a predefined threshold.

14. The method of claim 12, wherein an optimal DAG of a current iteration is associated with a current statistical score, and wherein an optimal DAG of a previous iteration is associated with a previous, not inferior statistical score, and wherein repeating the iterative process comprises:
calculating a selection probability; and
selecting the optimal DAG of the current iteration based on the selection probability.

15. The method of claim 14, wherein the selection probability is calculated such that for each pair of consecutive iterations of the local relearning process, the score of the optimal DAG of a first iteration of the pair of iterations is higher than the score of the optimal DAG of a second, later iteration of the pair of iterations.

16. The method of claim 1, wherein computing at least one CPT comprises computing all CPTs of the BN.

17. A system for detecting CD in a BN model, the system comprising: a non-transitory memory device, wherein modules of instruction code are stored, and at least one processor associated with the memory device, and configured to execute the modules of instruction code, whereupon execution of said modules of instruction code, the at least one processor is configured to:
receive a first version of the BN model, comprising a plurality of interconnected nodes, each node comprising a CPT representing statistic characteristics of a corresponding domain variable;
compute at least one CPT of at least one node of the first version BN based on an incoming data stream to produce a second version of the BN;
calculate a CPT distance value between at least one first CPT of the first version and at least one corresponding second CPT of the second version; and
identify at least one suspected node of the BN as undergoing CD based on the at least one calculated CPT distance values.

18. The system of claim 17, wherein the at least one processor is configured to perform a local relearning process by:
producing a plurality of DAGs, wherein each DAG comprises nodes of the BN, and represents a single structural change in the BN in relation to at least one suspected node;
for each DAG of the plurality of DAGs, calculating a statistical score, representing a likelihood that the DAG corresponds to the incoming data stream;
selecting a DAG among the plurality of DAGs based on the calculated statistical scores; and
producing an optimized version of the BN based on the selected DAG.

19. The system of claim 18, wherein the local relearning process is an iterative process, wherein each iteration comprises:
producing a plurality of DAGs;
selecting an optimal DAG, representing a single structural change in the BN in relation to a previous iteration, based on the calculated statistical scores;
calculating an improvement of the statistical score of the selected DAG in relation to the statistical score of a selected DAG of the previous iteration; and
repeating the iterative process, with the selected optimal DAG, based on the calculated improvement.

20. A method of mitigating, by at least one processor, CD in a BN model, the method comprising:
receiving a first version of the BN model, corresponding to a first timing, said BN model comprising a plurality of interconnected nodes, wherein each node represents a domain variable;
receiving a second version of the BN model, corresponding to a second timing;
identifying at least one node of the BN as suspected of undergoing CD between the first version of the BN model and the second version of the BN model; and
locally relearning the BN based on the identified suspected node.
